(19) United States
(12) Patent Application Publication
(10) Pub. No.: US 2026/0366763 A1
(43) Pub. Date: Nov. 19, 2026

(54) SEALED VESSEL, VESSEL FEEDTHROUGH ASSEMBLY AND METHOD OF PORTING A VESSEL WALL

(71) Applicant: NAKED ENERGY LTD., Surrey (GB)

(72) Inventors: Adrian Murrell, Surrey (GB); Steven Underwood, Surrey (GB)

(73) Assignee: NAKED ENERGY LTD., Surrey (GB)

(21) Appl. No.: 19/124,122

(22) PCT Filed: Oct. 24, 2023
(86) PCT No.: PCT/GB2023/052782

§ 371 Date: Apr. 24, 2025

(30) Foreign Application Priority Data
Oct. 28, 2022 (GB) 2216012.1

(51) Int. Cl. F24S 10/40; F24S 80/00; F24S 80/30; F24S 80/70

(52) U.S. Cl. CPC F24S 10/45; F24S 80/30; F24S 80/70; F24S 2080/015

(57) ABSTRACT

A vessel, such as an evacuated solar collector, comprises a wall formed of a first material having a first coefficient of thermal expansion “CTE”. A feedthrough passes through an aperture in the wall of the vessel and comprises a flange having a surface facing a surface of the wall, the feedthrough being formed of a material having a second CTE higher than the first CTE. A flexible seal is positioned between the wall and the flange and a clamping member is operable to move the flange towards the facing surface of the wall to compress the seal between the wall and the flange. A spacer is positioned between the clamping member and the flange, the spacer being formed of a material having a third CTE higher than the second CTE.

### TECHNICAL FIELD

The present invention relates to sealing vessels.

### BACKGROUND

Evacuated tube solar thermal collectors often require an air-tight seal to be made between the glass vacuum tube and metal heat exchanger pipework. In the case of direct flow collectors with a single walled vacuum tube this seal needs to separate vacuum and atmospheric pressure and must therefore be of high integrity. Creating a high integrity vacuum seal between dissimilar materials creates technical challenges, both in terms of the attachment method (whether mechanical or adhesive) and in relation to the robustness of the design across variable temperatures.

Similar technical challenges are present when a seal is to be formed between dissimilar materials, and not only in the case of evacuated tubes and other vessels. Therefore the technology disclosed here has applications outside the field of evacuated vessels.

Some sealed vessels need to operate across a wide temperature range. An example is an evacuated tube solar thermal collector. While temperatures during normal daytime operation are usually in the range 20-90 °C for building heating and hot water systems, at times when the fluid is not circulating the components can reach a much wider temperature range. At night in winter temperature may fall well below freezing. During the day, if fluid flow stops in sunny conditions (due to controls or pump or component failure) the absorber inside a vacuum tube can reach 200-300 °C.

In some sealed vessels such as evacuated tube solar thermal collectors, the vessel is made of glass and a feedthrough assembly including a flexible seal includes metal components. Metal and glass mostly have very different coefficients of thermal expansion “CTE”. Brass has a CTE of 18-19×10-6 m/m K, while borosilicate glass (commonly used in evacuated tube solar thermal collectors) has a CTE of only 3.3×10-6 m/m K. This means that brass parts expand and contract much more than borosilicate glass when temperature changes.

There are various types of vacuum seal that can be used between glass and metal, including:
1. Melted glass seal—this usually uses a glass “frit” (a glass “solder” that melts at a lower temperature than the main glass component).
2. Adhesive seal
3. O-ring seal.

Neither melted glass nor adhesive seals can accommodate temperature changes easily, as the dissimilar materials are bonded together and expand different amounts. There are some specialised approaches to solve this, such as the use of a very thin metal element that is mechanically flexible (as used in a Houskeeper seal). However, these type of seals are expensive, requiring precision machined parts and expensive manufacturing equipment.

O-ring vacuum seals can be more accommodating of mechanical movement and temperature variation. If the metal and glass are separated by an O-ring that is made of a flexible material (such as Ethylene Propylene Diene Monomer “EPDM” or Viton™) they have some freedom to expand and contract. However, to form a good vacuum seal, an O-ring must be held in good contact and under compression and there is a limit to the degree of materials expansion that can be accommodated.

A brass feedthrough to carry a copper pipe through the wall of a glass tube or a glass end cap may need a spacing of 15-20 mm between the O-ring face and the clamping nut. When a brass component 20 mm long is heated by 300 °C it will expand by 0.1 mm. This movement will reduce the amount of compression on the O-ring. Reduced compression will change the shape of the O-ring cross-section and reduce the contact area to the glass sealing face. This in turn will reduce the thickness of O-ring material that separates vacuum and atmosphere, which will increase the permeation rate of air through the O-ring. Therefore, the air leakage rate through the O-ring will rise and the lifetime of the vacuum tube (the duration that a good vacuum is maintained) will be reduced. In the worst case the contact between the brass or glass faces may be lost in one area of the seal and a rapid vacuum leak may occur.

A design solution is therefore required to counteract the thermal expansion effects seen in a vacuum seal between materials of different CTE. This solution would be applicable to evacuated tube solar thermal collectors but may also be applicable to other applications that require vessel to be sealed.

### SUMMARY

Embodiments of the invention are not limited to solving such problems and may include solutions to other problems.

This summary is provided to introduce a selection of concepts in a simplified form that will be further described below in the “Detailed Description” section. This summary is not intended to identify key features or essential features of the claimed subject matter, nor is it intended to be used to determine the scope of the claimed subject matter.

In the following, a sealed vessel is described in which two materials that have different CTE are connected. A third material is added, with a higher CTE than either of the first two materials, and this is used to compensate the difference in thermal expansion.

There is provided in the following a vessel comprising:
a wall formed of a first material having a first coefficient of thermal expansion “CTE”; a feedthrough passing through an aperture in the wall of the vessel and comprising a flange having a surface facing a surface of the wall, the feedthrough being formed of a material having a second CTE higher than the first CTE;
a flexible seal positioned between the wall and the flange; a clamping member operable to move the flange towards the facing surface of the wall to compress the seal between the wall and the flange; and
a spacer positioned between the clamping member and the flange, the spacer being formed of a material having a third CTE higher than the second CTE.

Due to the differences in CTE, when the temperature increases, the feedthrough expands in length much more than the thickness of the vessel wall. Ordinarily this would result in a reduction of the compression of the O-ring. However, with the spacer having an even higher CTE than that of the feedthrough, the expansion of the spacer cancels out at least partially if not entirely the expansion of the feedthrough. Therefore a design may be provided that is particularly robust across variable temperatures.

There is also provided a feedthrough assembly for a vessel made from a material having a CTE lower than 10×10-6 m/m K, for example glass. The feedthrough assembly may comprise:
a feedthrough comprising a flange having a surface to face a surface of the vessel wall in use, the feedthrough being formed of a material having a second CTE higher than the first CTE; a flexible seal to be positioned between the wall and the flange;
a clamping member operable to move the flange towards the facing surface of the wall to compress the seal between the wall and the flange; and
a spacer positioned between the clamping member and the flange, the spacer being formed of a material having a third CTE higher than the second CTE.

There is also provided a method of providing an access port in a wall of a vessel formed of a first material having a first coefficient of thermal expansion “CTE”, for example lower than 10×10-6 m/m K, the method comprising:
providing an access aperture in the wall,
arranging a feedthrough to pass through an aperture in the wall comprising a flange having a surface facing a surface of the wall, the feedthrough being formed of a material having a second CTE higher than the first CTE;
positioning a flexible seal between the wall and the flange;
arranging a clamping member to be movable to compress the seal between the wall and the flange; and
arranging a spacer between the clamping member and the flange, the spacer being formed of a material having a third CTE higher than the second CTE.

The vessel, feedthrough assembly and method may include any of the following optional features:

The clamping member may be operable from the opposite side of the wall from the flange.

The clamping member may be formed of the same material as the feedthrough. This helps to avoid the risk of galvanic corrosion which may occur if the clamping member and feedthrough are formed of different materials.

The spacer may be positioned between the clamping member and the wall of the vessel, in which case the flexible seal may be at least partially accommodated in a recess formed in a surface of the flange facing the surface of the wall of the vessel.

The spacer may be positioned between the flexible seal and the flange, in which case the flexible seal may be at least partially accommodated in a recess formed in a surface of the spacer facing the surface of the wall of the vessel.

The clamping member may surround a portion of the feedthrough. For example the clamping member may comprise a threaded nut movable along a corresponding threaded surface provided on the portion of the feedthrough extending outside the vessel. The portion of the feedthrough may extend outside or inside the vessel.

The wall of the vessel may be formed of a ceramic material and/or the feedthrough may be formed of a metal. For example the wall of the vessel may be formed of glass and/or the feedthrough may be formed of brass.

The third CTE may be at least 5 times higher than the first CTE.

The material of the spacer may be polytetrafluoroethylene “PTFE”.

The vessel may be evacuated, for example the vessel may comprise a solar collector.

### BRIEF DESCRIPTION OF THE DRAWINGS

Some embodiments of the invention will be described, by way of example, with reference to the following drawings, in which:

FIG. 1 is a cross sectional view of part of a wall of a vessel provided with a feedthrough;

FIG. 2 is a broken perspective view of a solar collector in which the vessel wall and feedthrough of FIG. 1 may be comprised; and

FIG. 3 is a perspective view of a parallel array of solar collectors of the kind shown in FIG. 3.

### DETAILED DESCRIPTION

Aspects of the invention will be understood from the following detailed description of embodiments, which are meant to be descriptive and not limiting. For the sake of brevity, some well-known features methods and systems, procedures components and circuits are not described in detail.

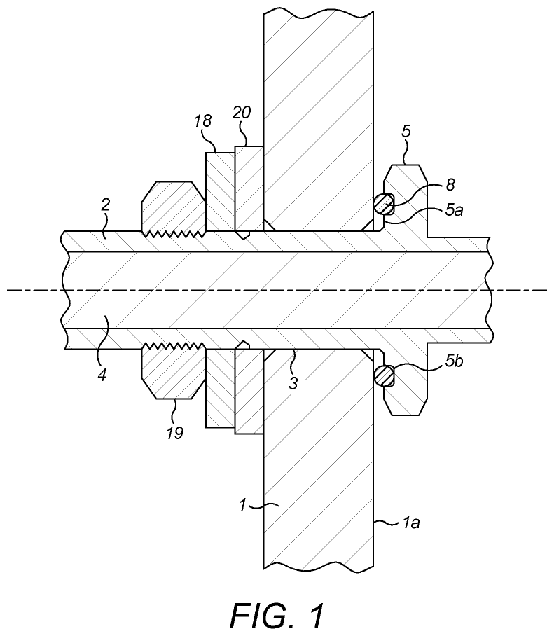

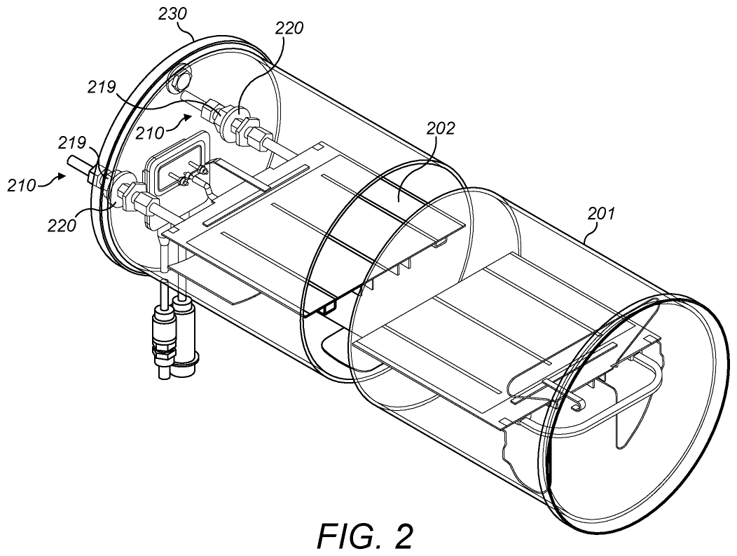

FIG. 1 is a cross sectional view of part of a wall 1 of a vessel provided with a feedthrough 2. An example of a vessel is described further with respect to FIG. 2. A feedthrough provides access from one side of the wall to the other, for example to the interior of the vessel from the outside. The feedthrough may comprise an annular member, although other shapes are possible, having a thickness larger than the vessel wall so as to protrude from the wall on both sides, for example to protrude into the vessel and extend outside the vessel.

The feedthrough may be hollow or solid. For example a fluid feedthrough may comprise a channel which may receive a pipe or that passes through or into the vessel in use. The pipe is generally sealed with respect to the feedthrough. An electrical feedthrough may comprise a solid conductive body to which electrical connections can be made, for example on both sides of the wall. The feedthrough needs to be sealed against the wall of the vessel.

The vessel wall 1 is formed of a first material having a first CTE. For example the vessel wall 1 may be made of glass. The feedthrough 2 is made of a material having a CTE higher than the CTE of the wall 1 material. For example the feedthrough may be made of brass.

The feedthrough 2 passes through an aperture 3 in the vessel wall 1 and comprises, on one side of the vessel wall 1, an extending portion 4, and on the other side of the vessel wall 1 a flange 5 having a surface 5a facing a surface 1a of the vessel wall 1.

A flexible seal 8 is positioned between the wall 1 and the flange 5, e.g. between the respective surfaces 1a and 5a. Various materials and shapes may be suitable for the seal as will be familiar to those skilled in this field. For example, the seal 8 may comprise an O-ring. Additionally or alternatively the seal 8 may be formed of a fluoroelastomer such as Viton™.

In order to compress the seal and ensure good surface contact between the seal 8 and respective surfaces with which it is in contact, a clamping member is provided, operable to move the flange 5 towards the wall 1 to compress the seal 8 between the wall 1 and the flange 5. In FIG. 1, the clamping member comprises a threaded nut 19 movable along a corresponding threaded surface provided on the portion 4 of the feedthrough extending outside the vessel 1. A washer 18 or annular disc is provided between the nut and the vessel wall 1.

It is not essential for the seal to be directly in contact the flange 5. For example one or more spacers may be present between the seal and the flange 5, whilst still enabling the seal 8 to be compressed between the wall 1 and the flange 5 and thereby form good surface contact with the surface 1a of the wall 1.

The surface facing the vessel wall 1 against which the flexible seal is compressed in use may be provided with a recess for locating the seal. For example, as shown in FIG. 1, the flexible seal 8 may be located or at least partially accommodated in a recess 5b formed in the surface 5a of the flange 5. The recess 5b may for example comprise an annular channel.

Other suitable clamping members may be used, for example but not limited to those which surround a portion of the feedthrough 2 extending on the opposite side of the vessel from the flange 5. In general the clamping member may be operable, for example by a human operator, from the opposite side of the wall 1 from the flange 5, as is the case with the threaded nut 19.

The clamping member may be formed from the same material as the feedthrough 2. Thus for example the threaded nut 19, and optionally also the washer 18, may be formed of brass.

The surface 5a of the flange 5 may face either the interior or the exterior surface of the vessel wall 1. The advantage to the flange 5 being on the interior surface is that the clamping member is more accessible, being on the outside. However the flange 5 and seal 8 can also be on the exterior surface. In the vacuum case for example there is some advantage to this in that the force due to atmospheric pressure is then also compressing the seal. This is feasible for example when the feedthrough is installed before the formation of the vessel is completed and/or before it is evacuated.

A spacer is positioned between the clamping member and the flange 5, formed of a material having a higher CTE than either the vessel wall 1 or the feedthrough 5. In the arrangement of FIG. 1, the spacer comprises an additional washer or annular disc 20 positioned between the washer 18 and the wall 1. Where the vessel is glass and the feedthrough is brass, a suitable material for the spacer 20 is Polytetrafluoroethylene “PTFE”.

In the arrangement illustrated in FIG. 1, the wall 1 separates the spacer from the flange, e.g. the PTFE washer 20 from the flange 5. In other words the spacer is positioned between the clamping member and the wall 1 of the vessel. In an alternative arrangement the spacer may be positioned between the flexible seal 8 and the flange. Then the flexible seal 8 would be compressed between the spacer and the wall by the action of the clamping member. The spacer could be provided with a recess to locate or at least partially accommodate the seal.

FIG. 1 shows an example of a vessel in which the wall formed of a first material having a first CTE, the feedthrough is formed of a material having a second CTE higher than the first CTE, and the spacer is formed of a material having a third CTE higher than the second CTE. This provides a design that is particularly robust across variable temperatures.

To take the example of glass, brass and PTFE, when the temperature increases, the brass feedthrough expands in length much more than the glass plate (thickness). Therefore the compression of the O-ring reduces. However, the PTFE washer has an even higher CTE than brass and the expansion of this part cancels out the expansion of the brass. With suitable choice of dimensions of the vessel wall, feedthrough and spacer, the compression of the O-ring may be maintained at a substantially constant amount, independent of temperature. The calculation below shows how these expansion amounts cancel out.

Analysis of thermal expansion of
VirtuHOT vacuum feedthrough parts

| CTE data | | | | thickness | |
|---|---|---|---|---|---|
| glass (boro) | 3.30E−06 | /C | o-ring | 0.4 | mm |
| brass | 1.90E−05 | /C | glass end cap | 10 | mm |
| PTFE | 1.40E−04 | /C | PTFE washer | 1.5 | mm |
| min temp | −40 | C | brass washer | 2 | mm |
| max temp | 260 | C | total length | 13.9 | mm |
| temp rise | 300 | | | | |

| Thermal expansion: | =CTE × temp rise × total length | |
|---|---|---|
| glass expansion | 9.9E−03 | mm |
| PTFE expansion | 6.3E−02 | mm |
| brass washer expansion | 1.1E−02 | mm |
| total expansion of clamped parts | 8.4E−02 | mm |
| brass expansion | 7.9E−02 | mm |
| resulting change | | |
| in o-ring compression: | 5.1E−03 | mm |

In this example, the brass feedthrough expands 7.9×10⁻² mm when the temperature is raised by 300 C, but the PTFE also expands by 6.3×10⁻² mm, resulting in a total change in O-ring compression of just 5×10⁻³ mm, which is negligible.

More generally, the thicknesses of the “clamped parts”, i.e. those between the clamp and the flange, and the length of the feedthrough between the clamp to the flange may be chosen such that the difference in compression over a desired temperature range is within a predetermined threshold, or tolerance.

The feedthrough, the seal and the clamping member, for example as illustrated in FIG. 1, comprise a feedthrough assembly which may be provided as a separate item for installation in a vessel.

A method of providing an access port in a wall of a vessel may comprise:
providing an access aperture in the wall, the wall being formed of a first material having a first CTE,
arranging a feedthrough to pass through an aperture in the wall comprising a flange having a surface facing a surface of the wall, the feedthrough being formed of a material having a second CTE higher than the first CTE;
positioning a flexible seal between the wall and the flange;
arranging a clamping member to be movable to compress the seal between the wall and the flange; and
arranging a spacer between the clamping member and the flange, the spacer being formed of a material having a third CTE higher than the second CTE.

The vessel, of which the wall 1 of FIG. 1 is a part, may comprise a solar collector. FIG. 2 shows in broken perspective view one example of a solar collector in which a feedthrough assembly as described here may be incorporated. Examples of solar collectors are shown and described in more detail in EP2898270A1 and EP3722698A1.

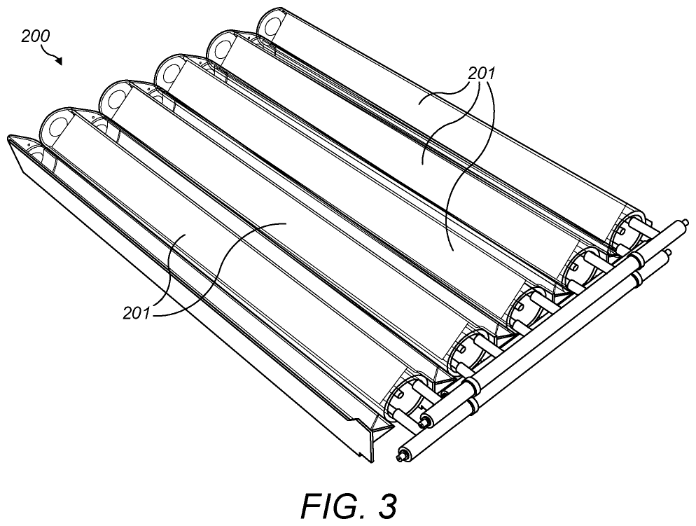

The solar collector of FIG. 2 comprises a vessel in the form of a sealed elongate transparent tube 201 containing a solar energy absorber assembly 202. Multiple tubes 201 each containing solar energy absorbers may be provided in a parallel array 200 as shown in FIG. 3.

The tube 201 shown in FIG. 2 is provided with two feedthrough assemblies 210 of the kind shown in FIG. 1, positioned in a circular end wall 230 of the tube 201. Some details are not illustrated but it can be seen that each feedthrough assembly 201 comprises a clamping member, in this example a threaded nut 219, operable from the outside surface of the circular end wall 230 of the vessel or tube 201. In the example of FIG. 2 a spacer 220 is provided between the end wall 230 and each threaded nut.

It will be understood that the benefits and advantages described above may relate to one embodiment or may relate to several embodiments. The embodiments are not limited to those that solve any or all of the stated problems or those that have any or all of the stated benefits and advantages.

Any reference to ‘an’ item refers to one or more of those items. The term ‘comprising’ is used herein to mean including the method steps or elements identified, but that such steps or elements do not comprise an exclusive list and a method or apparatus may contain additional steps or elements.

The figures illustrate exemplary methods. While the methods are shown and described as being a series of acts that are performed in a particular sequence, it is to be understood and appreciated that the methods are not limited by the order of the sequence unless otherwise stated. For example, some acts can occur in a different order than what is described herein. In addition, an act can occur concurrently with another act. Further, in some instances, not all acts may be required to implement a method described herein.

It will be understood that the above description of an embodiments is given by way of example only and that various modifications may be made by those skilled in the art. What has been described above includes examples of one or more embodiments. It is, of course, not possible to describe every conceivable modification and alteration of the above devices or methods for purposes of describing the aforementioned aspects, but one of ordinary skill in the art can recognize that many further modifications and permutations of various aspects are possible. Accordingly, the described aspects are intended to embrace all such alterations, modifications, and variations that fall within the scope of the appended claims.

What is claimed is:

1. A vessel comprising:
a wall formed of a first material having a first coefficient of thermal expansion “CTE”;
a feedthrough passing through an aperture in the wall of the vessel and comprising a flange having a surface facing a surface of the wall, the feedthrough being formed of a material having a second CTE higher than the first CTE;
a flexible seal positioned between the wall and the flange;
a clamping member operable to move the flange towards the facing surface of the wall to compress the seal between the wall and the flange; and
a spacer positioned between the clamping member and the flange, the spacer being formed of a material having a third CTE higher than the second CTE.

2. The vessel of claim 1, wherein the clamping member is operable from the opposite side of the wall from the flange.

3. The vessel of claim 1, wherein the clamping member is formed of the same material as the feedthrough.

4. The vessel of claim 1, wherein the spacer is positioned between the clamping member and the wall of the vessel.

5. The vessel of claim 4, wherein the flexible seal is at least partially accommodated in a recess formed in a surface of the flange facing the surface of the wall of the vessel.

6. The vessel of claim 1, wherein the spacer is positioned between the flexible seal and the flange.

7. The vessel of claim 6, wherein the flexible seal is at least partially accommodated in a recess formed in a surface of the spacer facing the surface of the wall of the vessel.

8. The vessel of claim 1, wherein the clamping member surrounds a portion of the feedthrough.

9. The vessel of claim 8, wherein the clamping member comprises a threaded nut movable along a corresponding threaded surface provided on the portion of the feedthrough extending outside the vessel.

10. The vessel of claim 1, wherein the wall of the vessel is formed of a ceramic material and the feedthrough is formed of a metal.

11. The vessel of claim 1, wherein the wall of the vessel is formed of glass.

12. The vessel of claim 1, wherein the feedthrough is formed of brass.

13. The vessel of claim 1, wherein the third CTE is at least 5 times higher than the first CTE.

14. The vessel of claim 1, wherein the material of the spacer is polytetrafluoroethylene “PTFE”.

15. The vessel of claim 1, wherein the vessel is evacuated.

16. The vessel of claim 1, wherein the vessel comprises a solar collector.

17. A feedthrough assembly for a vessel formed of a material having a first coefficient of thermal expansion “CTE” less than 10×10-6 m/m K, the feedthrough assembly comprising:
a feedthrough comprising a flange having a surface to face a surface of the vessel wall in use, the feedthrough being formed of a material having a second CTE higher than the first CTE;
a flexible seal to be positioned between the wall and the flange;
a clamping member operable to move the flange towards the facing surface of the wall to compress the seal between the wall and the flange; and
a spacer positioned between the clamping member and the flange, the spacer being formed of a material having a third CTE higher than the second CTE.

18. The feedthrough assembly of claim 17 configured such that the clamping member is operable from the opposite side of the wall from the flange.

19. The feedthrough assembly of claim 17, wherein the clamping member is formed of the same material as the feedthrough.

20. The feedthrough assembly of claim 17, configured for the spacer to be positioned between the clamping member and the wall of the vessel.

21. The feedthrough assembly of claim 20, wherein a recess is formed in a surface of the flange facing the surface of the wall of the vessel to at least partially accommodate the flexible seal.

22. The feedthrough assembly of claim 17, configured for the spacer to be positioned between the flexible seal and the flange.

23. The feedthrough assembly of claim 22, wherein a recess is formed in a surface of the spacer facing the surface of the wall of the vessel to at least partially accommodate the seal.

24. The feedthrough assembly of claim 17, wherein the clamping member surrounds a portion of the feedthrough.

25. The feedthrough assembly of claim 24, wherein the clamping member comprises a threaded nut movable along a corresponding threaded surface provided on the portion of the feedthrough.

26. The feedthrough assembly of claim 17, wherein the feedthrough is formed of brass.

27. The feedthrough assembly of claim 17, wherein the third CTE is at least 5 times higher than the first CTE.

28. The feedthrough assembly of claim 17, wherein the material of the spacer is polytetrafluoroethylene “PTFE”.

29. A method of providing an access port in a wall of a vessel formed of a first material having a first coefficient of thermal expansion “CTE”, the method comprising:
providing an access aperture in the wall,
arranging a feedthrough to pass through an aperture in the wall comprising a flange having a surface facing a surface of the wall, the feedthrough being formed of a material having a second CTE higher than the first CTE;
positioning a flexible seal between the wall and the flange;
arranging a clamping member to be movable to compress the seal between the wall and the flange; and
arranging a spacer between the clamping member and the flange, the spacer being formed of a material having a third CTE higher than the second CTE.

30. The method of claim 29, wherein the feedthrough is positioned outside the wall of the vessel.

31. The method of claim 29, wherein the feedthrough is positioned inside the wall of the vessel.

32. The method of claim 29, comprising arranging the clamping member to be operable from the opposite side of the wall from the flange.

33. The method of claim 29, wherein the clamping member is formed of the same material as the feedthrough.

34. The method of claim 29, comprising positioning the spacer between the clamping member and the wall of the vessel.

35. The method of claim 34, comprising forming a recess in a surface of the flange facing the surface of the wall of the vessel to at least partially accommodate the flexible seal.

36. The method of claim 29, comprising positioning the spacer between the flexible seal and the flange.

37. The method of claim 36, comprising forming a recess in a surface of the spacer facing the surface of the wall of the vessel to at least partially accommodate the seal.

38. The method of claim 29, wherein the clamping member surrounds a portion of the feedthrough designed to extend outside the vessel in use.

39. The method of claim 38, wherein the clamping member comprises a threaded nut movable along a corresponding threaded surface provided on the portion of the feedthrough.

40. The method of any of claim 29, comprising forming the feedthrough from brass.

41. The method of claim 29, wherein the third CTE is at least 5 times higher than the first CTE.

42. The method of claim 29, comprising forming the spacer from polytetrafluoroethylene “PTFE”.
